(19) United States
(12) Patent Application Publication
(10) Pub. No.: US 2007/0143156 A1
(43) Pub. Date: Jun. 21, 2007

(54) Method and website for making travel plans

(75) Inventor: Marc van Deursen, Hertogenbosch (NL)

Correspondence Address: GREER, BURNS & CRAIN, 300 S WACKER DR, 25TH FLOOR, CHICAGO, IL, 60606, US

(73) Assignee: Ciderhouse

(21) Appl. No.: 11/497,818

(22) Filed: Aug. 2, 2006

Related U.S. Application Data
(63) Continuation-in-part of application No. 10/987,673, filed on Nov. 12, 2004.

(51) Int. Cl. G06F 7/00

(52) U.S. Cl. 705/5; 707/4

(57) ABSTRACT

Embodiments of the present invention generally relate to a method and a website for making travel plans between an originating location and a destination that may be at least partially determined by weather criteria, travel time and cost, and preselected activities that may exist at the destination during the time period in which a trip is to be made.

This is a continuation-in-part of patent application having Ser. No. 10/987,673 filed Nov. 12, 2004.

### BACKGROUND OF THE INVENTION

The present invention generally relates to a method and website for making travel plans.

The travel industry has utilized computerized reservations systems (CRS) to access airline and rail schedules as well as book flights and other reservations that are travel related. These systems usually have certain databases and functionality that can only be used by subscribing travel agencies, but also provide similar but less extensive capabilities that can be used by individuals to plan as well as book travel arrangements for business and pleasure. There are many computerized reservation systems that are used worldwide and include systems that operate under the brands of Galileo, Amadeus, Sabre and Worldspan. These systems are predominantly used by travel agents and the industry and are used to book airline travel as well as other types of travel to a lesser extent, throughout the world. When travel arrangements are to be made, the traveler can directly access a website such as Orbitz, Travelocity, and others for the purpose of determining what flights are available at what time and date, and at what price. Alternatively, such information can be obtained from a travel agent who generally performs the same tasks. However, travel agents as well as others in the industry have databases and powerful search tools available to them that are not available to an individual traveler who attempts to make arrangements through the websites that are available to them.

Regardless of the databases that are typically accessed, all known systems uniformly operate on the basis that a traveler or operator inputs the originating location as well as the destination, the departure date as well as the return date and searches for available flights. The results of the search usually reveal the available flights (including nonstop or multiple stop flights) and their cost. If a selection is made, other important data such as the number of travelers, the class of ticket they wish to purchase, seat and meal options and like can often be specified. The many computerized reservation systems generally universally operate in this manner. It is desirable that other considerations be included in the travel planning and scheduling process.

### SUMMARY OF THE INVENTION

Embodiments of the present invention generally relate to a method and a website for making travel plans between an originating location and a destination that may be at least partially determined by one or more of many criteria that may exist during the time period in which a trip is to be made, including weather at a destination, activities that may be available, the types of travel that is desired, the cost of travel, and availability of travel packages that can include various combinations of air, ship, train, or vehicular travel together with accommodations at one or more destinations.

### DESCRIPTION OF THE DRAWINGS

FIG. 1 is a block diagram of the major components of the preferred embodiment of the present invention;

FIG. 2 is a flow chart illustrating the steps of the method of the preferred embodiment of the present invention;

FIG. 3 is a more detailed flow chart of a portion of the weather search process shown in FIG. 2;

FIG. 4 is a window or page of a website illustrating aspects of the selection process of the preferred embodiment;

FIG. 5 is another window illustrating other aspects of the selection process of the preferred embodiment of the present invention;

FIG. 6 is another window illustrating other aspects of the selection process of the preferred embodiment of the present invention;

FIG. 7 is a more detailed flow chart of a CRS search process;

FIG. 8 is another window illustrating the results of a search process utilizing the choices that were made in the windows of FIGS. 2 and 3; and

FIG. 9 is a window illustrating the booking process.

### DETAILED DESCRIPTION

Broadly stated, the preferred embodiment of the method of the present invention and the website that is used to implement the method utilizes one or more computerized reservations systems (CRS) including private reservation systems in combination with data sources or databases that provide weather related information. Such weather related information can include weather forecasts at various destinations, as well as averages of weather information for the particular time period of interest from one or several years.

If a traveler is uncertain as to a destination, but knows what activities he or she would like to participate in at the destination, such weather related information can be instrumental in the choice of a destination at the time in which the traveler wishes to travel. For example, if an individual wishes to escape to sunshine and warmth, that choice would result in a destination that would be quite different from one who wished to go skiing. The preferred embodiment of the present invention uses weather criteria as a significant factor, if not a major factor in determining destinations of a trip. The preferred embodiment of the method is preferably carried out over the Internet, but large area networks may also be used if appropriate. A website that can be accessed by potential travelers is a desired implementation of the method of the preferred embodiment.

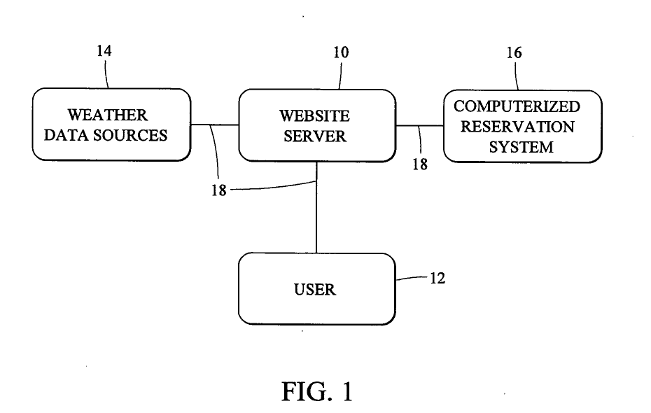

The basic components of the present invention are shown in FIG. 1, and includes a website server, indicated generally at 10, with the server being connected to one or more users 12, as well as to a weather data source 14 and a reservation system 16 (i.e., a CRS computerized reservation system or a private reservation system), with the connections between these components being made preferably through the Internet 18, although other large area networks could be used. As is known to those who professionally use CRS's, access to multiple CRS's is often made through the use of an application program interface (API) which enables queries to be simultaneously made to several CRS's. An API is an external web service that performs such simultaneous querying of multiple CRS's. The Internet is the preferred interconnection among most of these components because it is a worldwide communication network. Alternatively, private reservations systems can be used in conjunction with or in place of CRS's.

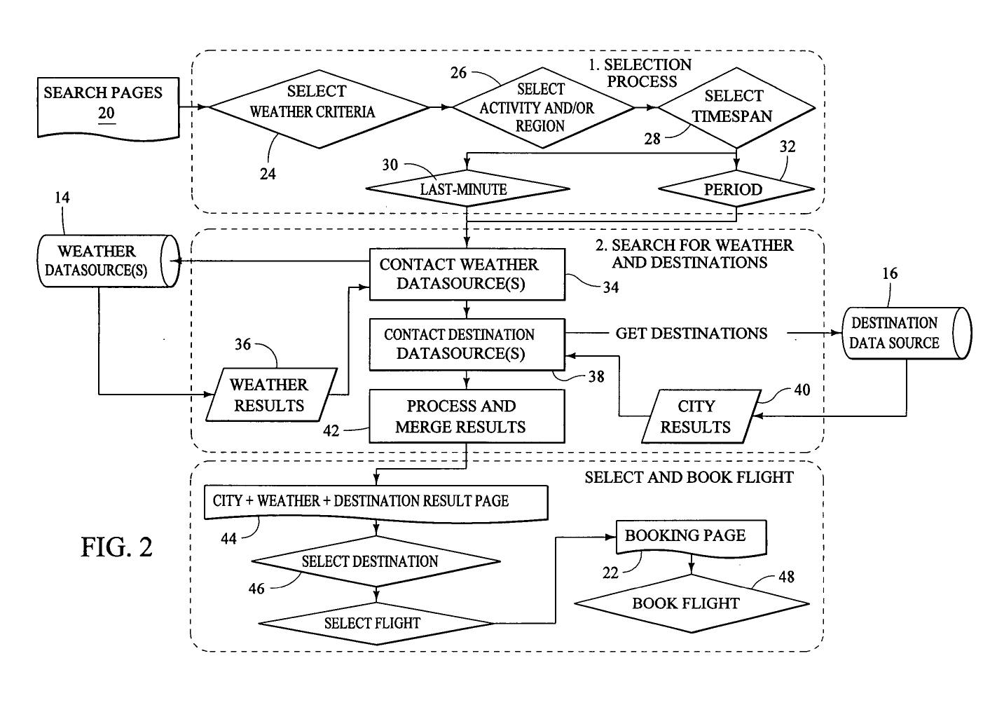

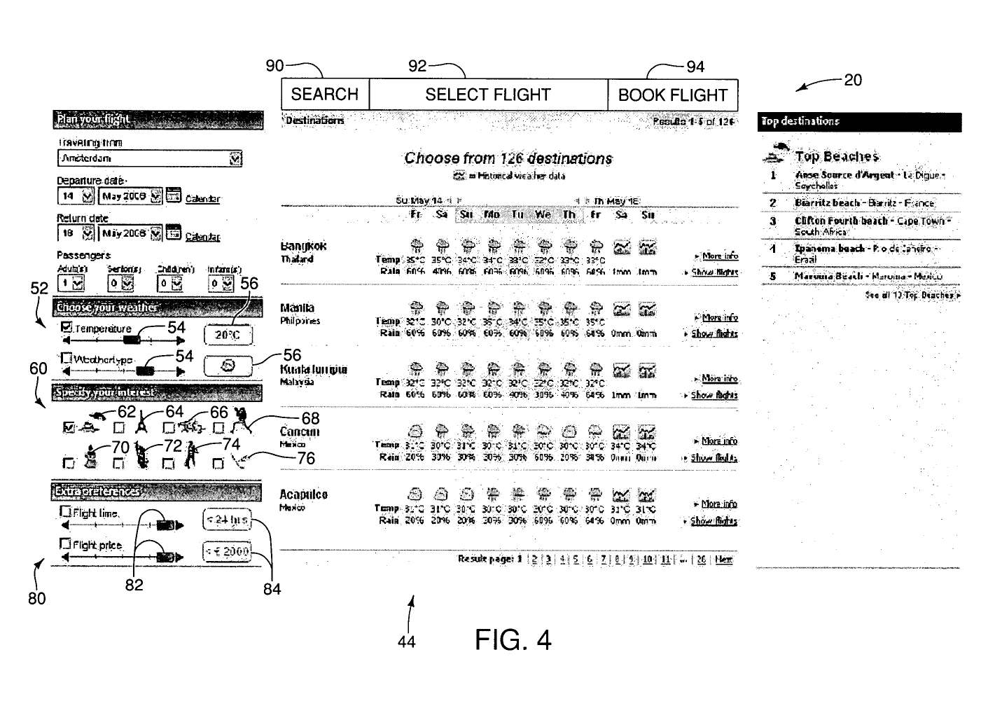

With regard to the operation of the preferred embodiment of the present invention, and referring to the flowchart shown in FIG. 2, the website server has software which produces the various windows shown in FIGS. 4-8 and also provides the engine for the operation and functionality of the website.

Turning now to FIG. 2, the server generates the search pages or windows 20, 21 and 22 which enables the user to make the various choices, select destinations and flights as well as book flights that are shown on these pages. Thus, the user will select weather criteria (block 24) as well as a region (block 26) and also select the time span for the proposed trip (block 28) which can encompass either the selection of the “last minute” choice (block 30) or a period (block 32) of time that can be general as in the spring, summer, autumn and winter, or specific departure and return dates.

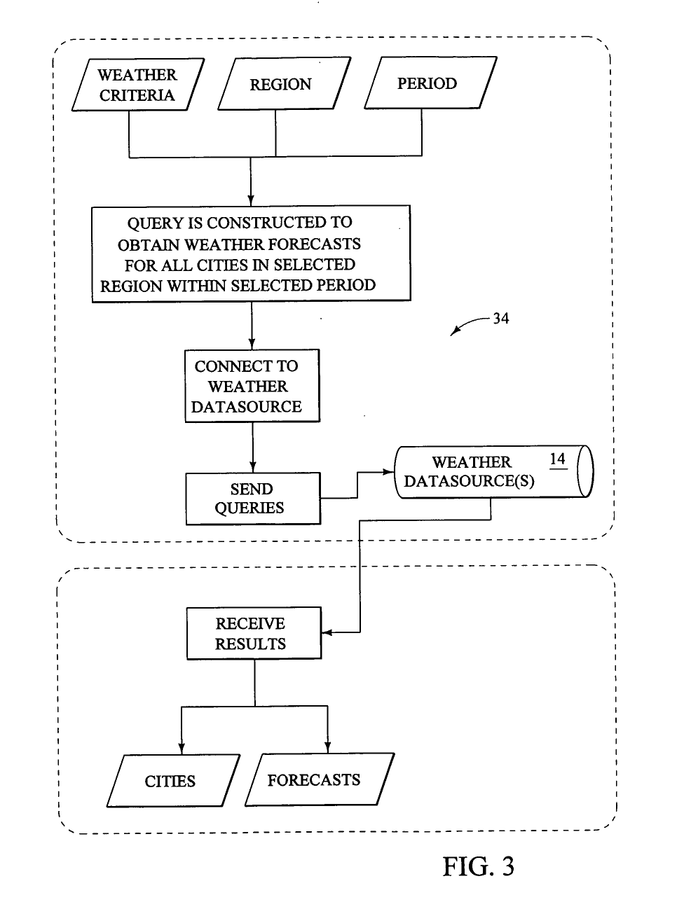

The initial action that is taken is for the server to contact weather data sources (block 34) to yield weather results (block 36). With regard to the contacting weather data sources action, the internal preferred process of the website server is shown in FIG. 3 where the server initially constructs queries based upon the traveler's indicated choices for weather criteria, region and period. More particularly, queries are constructed to obtain weather forecasts for all cities in a selected region within the selected period. The server then sets up connections to one or more weather data sources and sends the queries to the data source(s) to obtain a list of all cities in the geographical region that satisfy the selected weather criteria. The results in the form of forecasts of the cities are then received by the server (block 40) and provided to the server which then contacts destination datasources (block 38) to determine possible destination cities based upon other criteria that are supplied by the user.

In this regard, a user can visit the website and can make other selections with regard to criteria that are important in determining possible destinations, as is shown in the window or web page shown in FIGS. 4, 5 and 6. As shown in the upper left portion 50 of the window, a user must supply an originating location or field which is shown to indicate Amsterdam. A departure date is selected by the user, indicated as May 14, 2006 and a return date of May 18, 2006 is also indicated. Fields indicating the number of adults, children and infants are also illustrated. This information will be used to find flights or other means of travel from the originating city to a destination city, if and when the user has a final destination and wishes to search for, choose and book flights or other means of travel.

It should be understood from the above that the website is not limited to booking airline flights to destination cities, but may be provided by a travel agency or other entity which can book cruise ships, rail travel, bus travel or rental cars for a trip. The information being provided in these described fields is important for planning a trip using any type of travel.

In addition to this information, the user can choose the weather that is desired and/or expected at the destination city as is shown at 52 of the window 20. In this regard, there are two possible weather related tools that may be used to choose a possible destination, those being temperature and weather type. Each of the these choices has a selection box, which if selected (preferably by moving a cursor to the box and clicking a mouse switch), then shows a checkmark in the box. When either or both of these tools are activated, a slider icon 54 can be manipulated to change their operational characteristics. Each of these weather related tools also has an associated display window, with the temperature display window 56 indicating the specific temperature being selected by moving the slider icon 54 to the left or the right. As expected, moving the temperature slider icon 54 to the left will display a lower temperature and moving it to the right will show a higher temperature. The range of temperature may extend from minus 10° to plus 40° C., for example. Also as is common, the slider icons 54 can be moved by placing the cursor on the slider icon, while depressing a mouse switch and then moving the cursor either left or right as desired.

In the center of the window 20 are a list of destinations 44, the number of which may vary dramatically depending upon the temperature that has been selected by the user. As shown in FIG. 4, there are 126 destinations including Bangkok and Manila. It should be apparent if the temperature slider icon 54 was moved to a cold temperature, these destinations would not be listed.

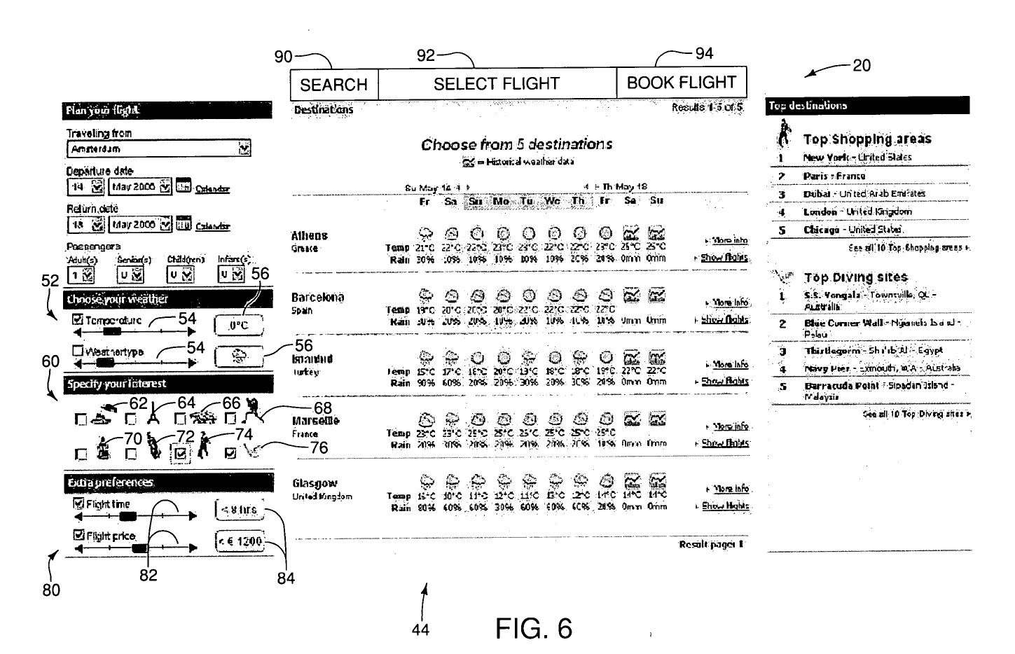

The other weather type tool, when its associated box is checked, activates its associated slider icon 54, which can be moved from a far rightward position indicating a sunny condition, where the sun would be shown in the adjacent display window 56, to partly cloudy condition as shown in FIG. 4, as well as a rainy condition as shown in FIG. 6. If the user wishes to have sunshine for spending time on a beach, a forecast of rain for some destinations would result in those destinations being removed from the list of possible destinations 44.

The webpage 20 also includes a section 60 that enables the user to specify possible interests or activities that they would like to participate in at the destination, and a total of eight different icons with associated boxes being illustrated, including a beach icon 62, a city trip icon 64, a horse racing icon 66, a hiking icon 68, a snowman or skiing icon 70, a golf icon 72, a shopping icon 74 and a diving icon 76. Additional or different icons can of course be used to signify other interests, such as dining, entertainment and/or gambling, for example.

As shown in FIG. 4, the beach icon 62 is checked which affects the number of destinations that are available. The list 44 indicates 126 possible destinations, and it is apparent that those listed are cities that have beaches.

Another feature may be helpful for the user to pick a destination is the right column shown in FIG. 4, which identifies five top beaches. These top beaches can be determined in various ways, depending upon what criteria are used in the selection and by the provider of the website. If it is a travel agency, those top beaches may be the ones where they sell the most travel trips to the customers, or the ones who are most highly recommended by their customers, or they may be lists that result from paid advertisers.

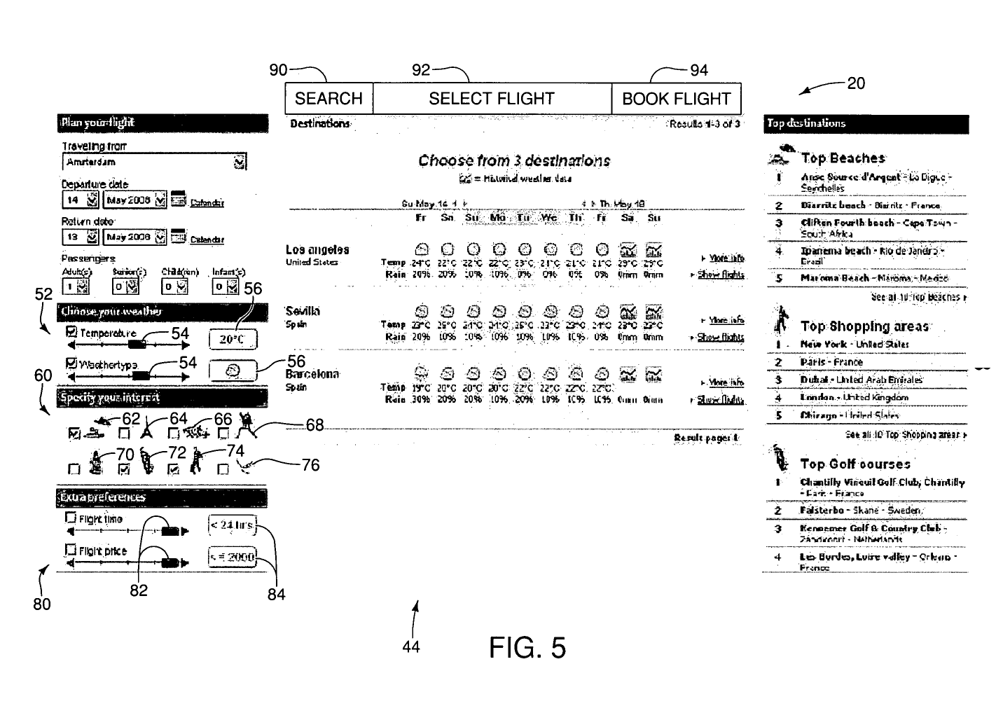

Referring to FIG. 5, the golfing icon box as well as the shopping icon box have been selected in addition to the beach icon box and the top destinations column on the right include five top shopping areas and five top golf courses. Since there are three activities or interests that are being addressed, the number of destinations is proportionally reduced and only three destinations are illustrated in FIG. 5. In FIG. 6, the diving and shopping icons have been selected and only five destinations are indicated in the list 44. The right column indicates five top dive sites, as well as five top shopping areas.

Other selections can be made in the lower left section, indicated generally at 80, which has two criteria tools that are available for selection, those being flight time and flight price. If the flight time box is checked, then its slider icon 82 can be moved to change the maximum length of a flight which can be from two to twenty-four hours, for example, but which can be varied as desired. The flight time duration is shown in the associated display window 84. Similarly, the other choice is the flight price, which has an associated slider icon 82 and display window 84 which enables the user to set a maximum amount for the ticket that he will buy. While the range of price can obviously be varied, it may range from 200 to 2,000 Euros, for example.

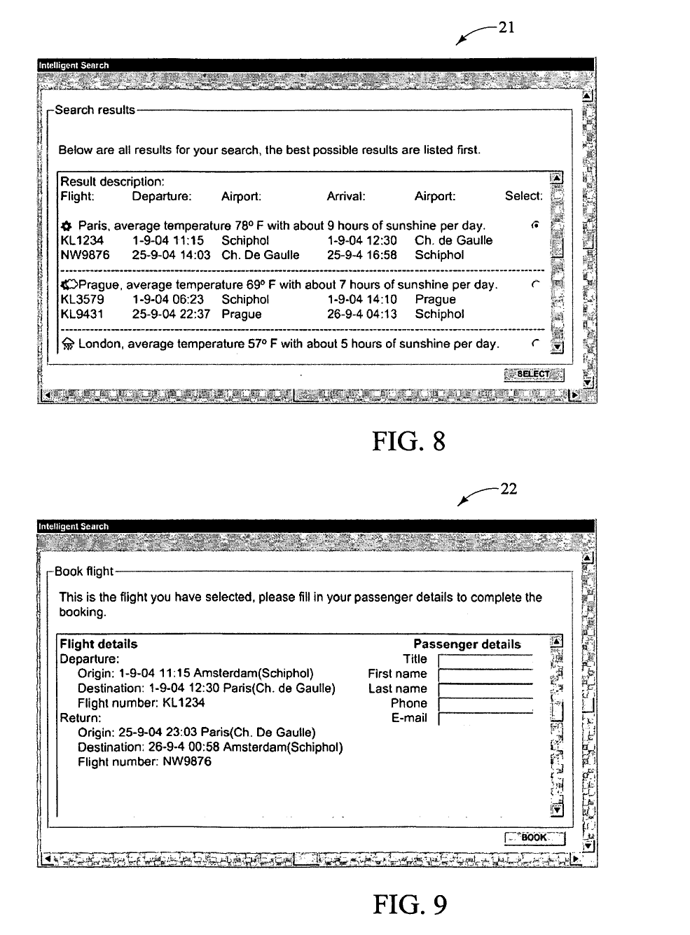

As a result of the selection process, the possible destinations are provided as a result of merging the weather related criteria with the activity criteria, which produces the destinations that are listed in the middle column 44 of the web page 20 (also block 44 in FIG. 2). From those possible destinations, the user can then select a destination (block 46) and then proceed to do searches for flights to the desired destination city by pressing a search icon 90. This will result in a list of possible flights from which one can be selected by pressing an appropriate icon 92 and then booking the desired flight by depressing an appropriate icon 94. The results of a search is preferably shown in a webpage, such as that shown in FIG. 8 and booking can be accomplished by a webpage, such as that shown in FIG. 9. The weather data sources can be any data source that supplies weather forecast data or historical information that may include weather criteria averages for a particular destination. In this regard, averages of high and low temperatures, amount of rain, wind speed, snowfall, snow accumulation and amount of sunshine and the like may be obtained over one or several years for the desired time span of the trip and depending upon the queries that were constructed, the results of them is returned by the weather data source preferably for each city. Additionally, more current weather conditions or criteria may also be returned. Particularly, the accumulated snow in a skiing area may be very desirable information. Based upon the results of the weather queries, one or several cities in the geographical area may satisfy the weather criteria.

The website server then initiates the action to contact the computerized reservation system (block 38) to obtain destination information for all cities in the region that satisfied the weather criteria for the specified dates.

While it may be done many different ways, it is preferred that destination results would be generated based upon some reasonable lead time from the time of the request, i.e., one or two weeks in the future, and have a duration that is commonly scheduled, such as one or two weeks. However, representative results may be returned in many different ways. It may be desirable to require the traveler to specify a narrower range of departure and return dates for a trip. The destination results are returned to the website server (block 40) which processes and merges the results (block 42).

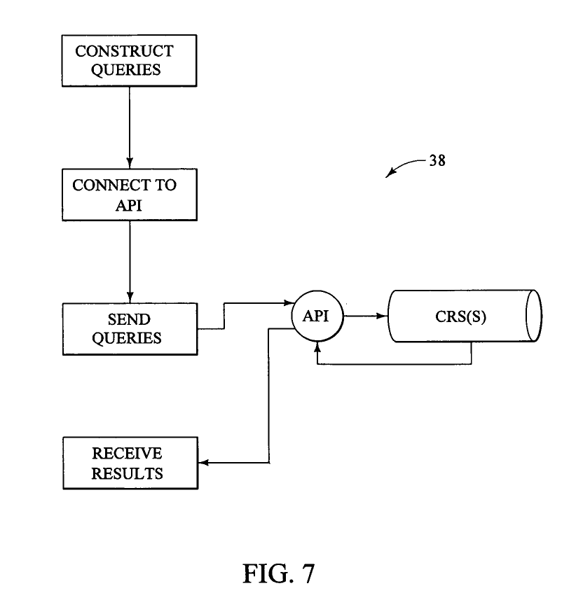

With regard to contacting a CRS, there are several systems including the Galileo, Amadeus, Sabre and Worldspan systems that provide airline scheduling information. There are other CRS's that can provide hotel availability and pricing, as well as holiday travel packages from a tour operator The preferred internal process is shown in FIG. 7, and begins with the server constructing the necessary queries based on the cities that were returned by the weather data sources and/or destination data sources. The server then connects to an API which is an external web service that can query multiple computer reservation systems simultaneously and the results of the queries are then received by the server (block 40).

The results of the search are displayed in a search result window as shown in FIG. 8, which in the illustrated example lists a flight to Paris from Amsterdam as well as a return flight and the indication that the average temperature is 78° F. with about nine hours of sunshine per day. This is for the time period of September 1 through September 25. A similar flight to Prague is listed below the Paris flight, with the various flight choices being displayed.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the following claims.

What is claimed is:

1. A server powered website for determining travel plans for at least one traveler from an originating location to a destination, said server being connectable in a network that comprises weather related data sources and interest activity data sources, said website comprising:
at least one web page that enables a user to:
select an originating location of the traveler;
select a time period in which the travel is to occur;
select interest activities that the traveler can pursue at a destination;
select weather criteria for a destination;
the server searching one or more weather related databases to locate weather related destinations having said selected weather criteria in said selected time period;
the server searching one or more destination data sources to locate activity related destinations that satisfy selected interest activities;
the server processing the results of said weather related destination search and said activity related destination search and displaying destinations that were located by both said weather related destination and activity related destination searches.

2. A website as defined in claim 1 wherein the network further comprises at least one computerized reservation system having access to airline scheduling data sources, said at least one web page enables a user to select a maximum flight time from the originating location to a destination, said server searching said airline scheduling data sources to locate destinations that are within said maximum flight time from the originating location, said server processing the results of said airline scheduling related destination search together with the results of said weather related destination search and said activity related destination search and displaying destinations that were located by all of said weather related destination, said activity related destination and said airline scheduling related destination searches.

3. A website as defined in claim 1 wherein the network further comprises at least one computerized reservation system having access to airline scheduling data sources, said at least one web page enables a user to select a maximum cost of an air fare from the originating location to a destination, said server searching said airline scheduling data sources to locate destinations that are within said maximum cost from the originating location, said server processing the results of said airline scheduling related destination search together with the results of said weather related destination search and said activity related destination search and displaying destinations that were located by all of said weather related destination, said activity related destination and said airline scheduling related destination searches.

4. A website as defined in claim 1 wherein the network further comprises at least one computerized reservation system having access to airline scheduling data sources, said at least one web page enables a user to select a maximum flight time and cost of an air fare from the originating location to a destination, said server searching said airline scheduling data sources to locate destinations that are within said maximum flight time and cost from the originating location, said server processing the results of said airline scheduling related destination search together with the results of said weather related destination search and said activity related destination search and displaying destinations that were located by all of said weather related destination, said activity related destination and said airline scheduling related destination searches.

5. A website as defined in claim 2 wherein said at least one web page has a flight time selection section for selecting a maximum flight time, with an activating box, a movable icon for varying the flight time and a display window for displaying the maximum flight time.

6. A website as defined in claim 3 wherein said at least one web page has a flight price selection section for selecting a maximum flight cost, with an activating box, a movable icon for varying the flight cost and a display window for displaying the maximum flight cost.

7. A website as defined in claim 2 wherein said at least one computerized reservation system include one or more of a private reservation system, a CRS such as the Galileo, Amadeus, Sabre and Worldspan systems.

8. A website as defined in claim 1 wherein said network is the Internet.

9. A website as defined in claim 1 wherein server searching one or more weather related databases comprises the server:
constructing queries for said selected weather criteria;
connecting to one or more weather forecasting data sources;
sending said queries to said one or more weather forecasting data sources;
receiving city and weather forecasting data identifying one or more cities in said geographical region that match said weather criteria.

10. A website as defined in claim 1 wherein said at least one web page has a weather criteria selection section for selecting a desired temperature, with an activating box, a movable icon for varying the temperature and a display window for displaying the temperature selected.

11. A website as defined in claim 10 wherein said movable icon is a slideable icon that can be moved when a user contacts the icon with a cursor and selects the icon with a mouse and drags it from its original position when selected.

12. A website as defined in claim 1 wherein said at least one web page has a weather criteria selection section for selecting a desired weather type, with an activating box, a movable icon for varying the weather type and a display window for displaying the weather type selected.

13. A website as defined in claim 12 wherein said weather types comprise at least sunny, cloudy and rainy conditions.

14. A website as defined in claim 1 wherein said at least one web page has an interest activities selection section for selecting at least one interest activity, each activity having with an activating box, and an associated icon that represents the activity.

15. A website as defined in claim 14 wherein said interest activities selection section includes a plurality of activating boxes and associated icons, comprising one or more from the group of:
golfing;
hiking;
shopping;
beach;
diving;
famous cities;
skiing; and
racing.

16. A website as defined in claim 15 wherein said at least one web page comprises a top destination section associated with said interest activities selection section, wherein a plurality of suggested destinations are listed for a predetermined number of activated boxes.

17. A website as defined in claim 1 wherein the website is configured to enable a user to:
specify the number and relative ages of travelers for which travel plans are being made;
choose a destination from the displayed list of destinations; and
select flights to the chosen destination; and
book the selected flights.

18. A server powered website for determining travel plans for at least one traveler from an originating location to a destination, said server being connectable in a network that comprises weather related data sources, interest activity data sources and airline scheduling data sources, said website comprising:
at least one web page that enables a user to:
select an originating location of the traveler;
select a time period in which the travel is to occur;
select interest activities that the traveler can pursue at a destination;
select weather criteria for a destination;
the server searching one or more weather related databases to locate weather related destinations having said selected weather criteria in said selected time period;
the server searching one or more destination data sources to locate activity related destinations that satisfy selected interest activities;
the server processing the results of said weather related destination search and said activity related destination search and displaying destinations that were located by both said weather related destination and activity related destination searches.
the server accessing at least one flight reservation system having access to the airline scheduling data sources;
said at least one web page enabling a user to select at least one of a maximum flight time or a maximum flight price for a flight from the originating location to a destination, said server searching said airline scheduling data sources to locate destinations that are within said maximum flight time from the originating location, said server processing the results of said airline scheduling related destination search together with the results of said weather related destination search and said activity related destination search and displaying destinations that were located by all of said weather related destination, said activity related destination and said airline scheduling related destination searches.
